(19) United States
(12) Patent Application Publication
(10) Pub. No.: US 2017/0211508 A1
(43) Pub. Date: Jul. 27, 2017

(54) SYSTEM AND METHOD FOR VALVE SIZE RATIO AND IGNITER PLACEMENT

(71) Applicant: Cummins Inc., Columbus, IN (US)

(72) Inventors: Patrick M. Pierz, Hood River, OR (US); Leon A. LaPointe, Columbus, IN (US)

(21) Appl. No.: 15/321,631

(22) PCT Filed: Jun. 30, 2015
(86) PCT No.: PCT/US2015/038504

§ 371 Date: Dec. 22, 2016

Related U.S. Application Data
(60) Provisional application No. 62/018,972, filed on Jun. 30, 2014.

(51) Int. Cl. F02F 1/42; F02B 43/10; F01L 1/26

(52) U.S. Cl. CPC F02F 1/4214; F01L 1/26; F02B 43/10; F02F 2001/247

(57) ABSTRACT

An engine including a gaseous fuel system; a cylinder including a flat combustion face, the flat combustion face including four valves, each valve positioned in a port, the four valves including two intake valves positioned to selectively meter intake of charge into the cylinder via respective ports and including two exhaust valves positioned to selectively meter output of exhaust from the cylinder via respective ports. Intake valves are larger than exhaust valves and an ignition source is offset from center of a combustion surface.

### PRIORITY

This application claims the benefit of PCT Application No. PCT/US2015/038504 filed Jun. 30, 2015, which claims the priority of U.S. Provisional application Ser. No. 62/018,972 filed Jun. 30, 2014 titled “System and Method for Valve Size Ratio and Igniter Placement.” The disclosures of which are hereby incorporated by reference.

### FIELD OF THE DISCLOSURE

The present invention relates generally to systems for controlling volumetric efficiency in gaseous fueled internal combustion engines, and more specifically to systems for controlling volumetric efficiency by sizing of the intake and exhaust valves and by the location of the igniter.

### BACKGROUND

Engines operate by providing heat, oxygen, and fuel in the proper combination (air/fuel ratio) to produce contained combustion within the engine. Operation below the full rated load at a given engine speed is termed part load operation, and requires the engine output to be restricted in order to maintain a given engine speed. Part load operation of spark ignited engines is conventionally achieved by the use of a throttle to restrict the airflow into the engine, hence allowing the quantity of fuel that is injected to be reduced, whilst maintaining a constant air-fuel ratio (AFR).

The ratio of the trapped charge mass to the maximum mass of charge at its intake density that could be contained in the cylinder is termed the volumetric efficiency. When operating under full load conditions, the volumetric efficiency of an internal combustion engine should be as high as possible so that the mass of air-fuel mixture, and hence the power output, is maximized.

Engines are therefore designed to minimize the restriction of charge flowing into the engine, so that the charge can be drawn into the cylinder more easily at the given intake manifold condition. Flow losses are generated when drawing air from the manifold into the cylinder. These flow losses are a part of the pumping work incurred by the engine. Pumping work is a load that robs the useful work able to be performed by the engine.

Having a high geometric compression ratio in a cylinder can allow for high power output or higher efficiency at a given power output by providing a high expansion ratio potential. If the compression ratio is too high, the fuel will self-ignite, either from the heat generated by the compression, from the heat of the cylinder walls, or from another source. Self-ignition provides an uncontrolled source of ignition within a cylinder. Uncontrolled ignition sources have the potential to produce knock within an engine.

To offset the increase in knock potential associated with an increase in the geometric compression ratio, the intake valve event duration is sometimes reduced, thereby decreasing the effective compression ratio, all done without sacrificing the expansion ratio increase. The reduced intake valve event has the effect of reducing the volumetric efficiency and hence the engine power.

What is therefore needed is a system and method for maintaining knock margin and engine power while increasing the geometric compression ratio.

### BRIEF DESCRIPTION OF THE DRAWINGS

FIG. 1 is a diagram of one illustrative embodiment of a system of an internal combustion engine;

FIG. 2 is a diagram of one overhead view of an illustrative embodiment of a cylinder of the present disclosure showing location and sizing of valves and an igniter;

FIG. 3 is a cross-sectional view of a cylinder head showing valve bores/ports and an igniter bore of the embodiment of FIG. 2; and

FIG. 4 is a lower partial plan view of the cylinder head of FIG. 3.

### DETAILED DESCRIPTION

For the purposes of promoting an understanding of the principles of the invention, reference will now be made to a number of embodiments illustrated in the drawings and specific language will be used to describe the same. It will nevertheless be understood that no limitation of the scope of the invention is thereby intended.

Briefly, in one example, an engine is provided including a gaseous fuel system; a cylinder including a flat combustion face, the flat combustion face including four valves, each valve positioned in a port, the four valves including two intake valves positioned to selectively meter intake of charge into the cylinder via respective ports and including two exhaust valves positioned to selectively meter output of exhaust from the cylinder via respective ports; each of the ports for the four valves defining a port diameter; the port diameter for the intake valves being greater than the port diameter for the exhaust valves.

In another example an engine is provided including: a gaseous fuel system; a cylinder including four valves defined in a circular combustion face of the cylinder, the four valves each including a valve head, the valve heads presenting co-planar combustion surfaces; and an ignition source disposed in the combustion face, the ignition source being offset from a center of the combustion face in a direction towards the exhaust valves.

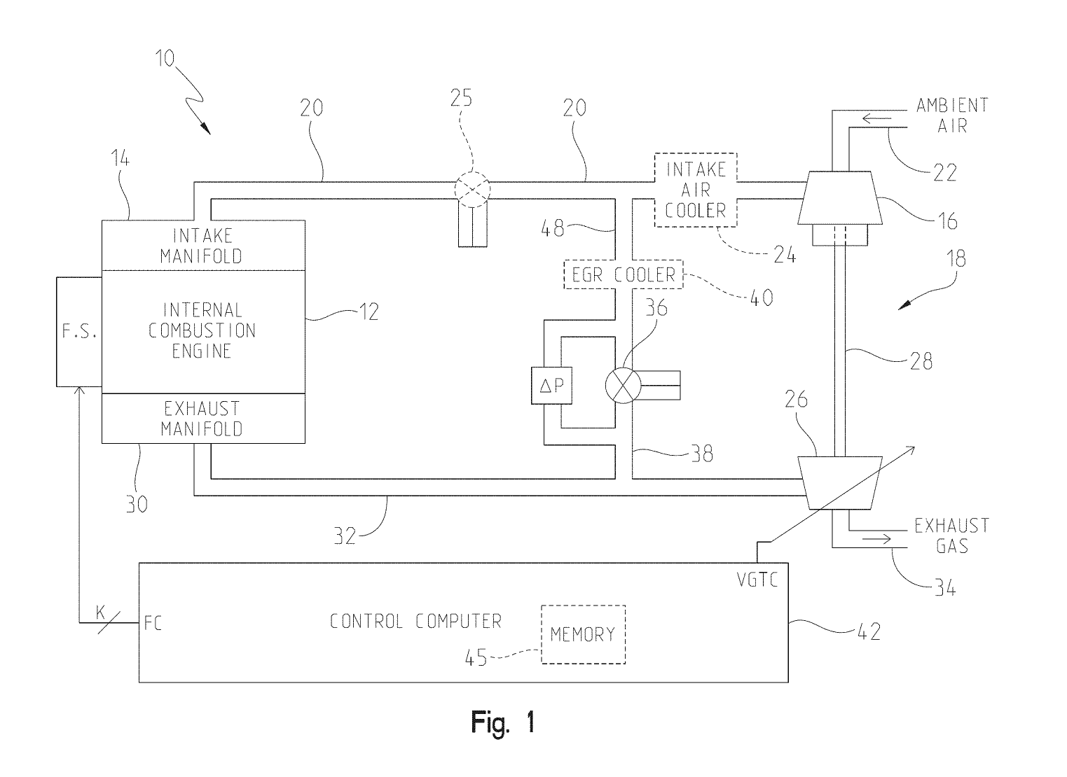

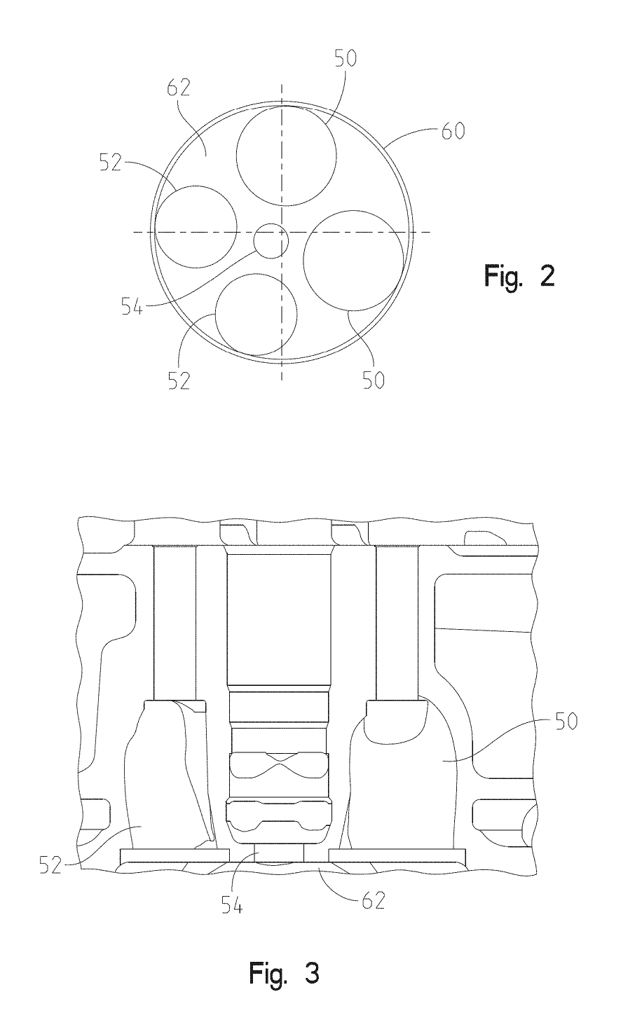

Referring now to FIG. 1, a diagram of one illustrative embodiment of a system 10 for controlling charge flow in a turbocharged internal combustion engine is shown. System 10 includes an internal combustion engine 12 having an intake manifold 14 fluidly coupled to an outlet of a compressor 16 of a turbocharger 18 via an intake conduit 20, wherein the compressor 16 includes a compressor inlet coupled to an intake conduit 22 for receiving fresh ambient air therefrom. Optionally, as shown in phantom in FIG. 1, system 10 may include an intake air cooler 24 of known construction disposed in-line with intake conduit 20 between the turbocharger compressor 16 and the intake manifold 14. Engine 12 is illustratively an engine where the charge (such as air) and fuel is mixed prior to the start of combustion (referred to herein as pre-mixed fuel). Engine 12 is illustratively an engine with in-line cylinders, as shown in FIG. 3.

System 10 further includes an intake charge (throttle) valve 25 disposed in-line with intake conduit 20 between the turbocharger compressor 16 and the intake manifold 14. The turbocharger compressor 16 is mechanically and rotatably coupled to a turbocharger turbine 26 via a drive shaft 28, wherein turbine 26 includes a turbine inlet fluidly coupled to an exhaust manifold 30 of engine 12 via an exhaust conduit 32, and further includes a turbine outlet fluidly coupled to ambient via an exhaust conduit 34. Optionally, an EGR valve 36 is disposed in-line with an EGR conduit 38 fluidly coupled at one end to the intake conduit 20 and an opposite end to the exhaust conduit 32, and an EGR cooler 40 of known construction may optionally be disposed in-line with EGR conduit 38 between EGR valve 36 and intake conduit 20 as shown in phantom in FIG. 1. In one embodiment, EGR conduit 38 is coupled to exhaust of less than all cylinders of engine 12. The cylinders coupled to EGR conduit 38 in such a setup are referred to as dedicated EGR cylinders. In that their exhaust is dedicated to feeding the EGR conduit 38. In such an embodiment, exhaust of non-dedicated cylinders is routed to turbocharger turbine 26.

System 10 includes a control computer 42 that is generally operable to control and manage the overall operation of engine 12. Control computer 42 includes a memory unit 45 as well as a number of inputs and outputs for interfacing with various sensors and systems coupled to engine 12. Control computer 42 is, in one embodiment, microprocessor-based and may be a known control unit sometimes referred to as an electronic or engine control module (ECM), electronic or engine control unit (ECU) or the like, or may alternatively be a general purpose control circuit. In any case, control computer 42 includes one or more control algorithms for controlling fueling and charge flow in engine 12.

Volumetric efficiency is a term that refers to the efficiency with which the engine can move the charge into and out of the cylinders. More specifically, volumetric efficiency is a ratio (or percentage) of the quantity of air that is trapped by the cylinder during induction over the swept volume of the cylinder under static conditions. Volumetric Efficiency can be improved in a number of ways.

In one embodiment, control computer 42 is configured to run engine 12 on a Miller cycle. Accordingly, the valve timing dictated by the control computer 42 is Miller-type timing. In the Miller cycle of the present embodiment, (having four cycles/strokes: intake, compression, combustion, and exhaust) the intake valve is closed before the piston reaches bottom dead center on an intake stroke. Accordingly, as the piston proceeds to bottom dead center once the intake valve is closed, the charge volume is temporarily expanded. The piston then begins its compression stroke. However, due to the “early” closing of the intake valve, the compression ratio of the compression stroke is effectively less than if the intake valve were closed at bottom dead center (thus using the full cycle length for compression). Reducing the effective compression ratio reduces the likelihood of self-ignition by the fuel.

Referring to FIG. 2, a diagram showing the locations of intake valves (in bores 50), exhaust valves (in bores 52), and ignition source (in bore 54), within the footprint of cylinder 60 are shown. It should be appreciated that the valves bores 50, 52 are defined in an upper wall 62 of cylinder 60. Upper wall 62 is illustratively a flat wall portion that presents a flat cylinder head combustion face. Intake and exhaust valves further include valve heads. While the valve heads (and stems) are not actually shown, the valve heads are conventionally shaped (but not sized) and biased to a closed position in which the valve heads abut seats of bores 50, 52 to seal therebetween. Given the shown locations of valve bores 50, 52 (and igniter bore 54) one of skill in the art readily appreciates the valve pieces that are present as part of the present disclosure. In one embodiment the valve heads present flat combustion surfaces. When the valves are closed, the valve heads are planar with the flat cylinder head combustion face 62. Furthermore, when the valves are closed, the flat combustion surfaces of the valve heads are co-planar. However, other embodiments are envisioned where the valve heads present domed surfaces.

In one embodiment, intake valves (bores 50) are larger than exhaust valves (bores 52). In the present exemplary embodiment being “larger” is achieved by having a valve diameter that is between 1.1 to 1.4 times larger. This diameter is illustratively the valve head outside diameter, inner seat diameter, or throat diameter. However, other embodiments are envisioned where other diameters are employed that meet the sizing details described herein.

Larger diameter intake ports present less resistance to flow of charge therethrough. Accordingly, the lower resistance to flow presents less of a pumping load on the engine as it operates an intake cycle for a cylinder. Further, for a chosen compression ratio and boost pressure, larger intake valves provide for more fuel and air to be received in the cylinder. Accordingly, greater power and/or efficiency is provided.

It should be appreciated that the different sizings of intake valves and exhaust valves bores 50, 52 change the spatial distribution of the bores 50, 52 in the cylinder head combustion face. While equally sized valves/bores are amenable to having solid mass in the middle of the valves that is has a center of mass that is generally co-located with the center of the cylinder head combustion face 62, differential sizings of bores 50, 52 cause the center of mass of the mass in the middle of the valves to be offset from the center of the circular cylinder head combustion face. The differential sizings of bores 50, 52 further offset the locations of the bores and by extension their ports. The mass between the bores 50, 52 is further present to allow properly sized walls to exist between valve ports and between valve ports and an igniter bore 54 that receives the igniter, FIG. 3, as discussed further below.

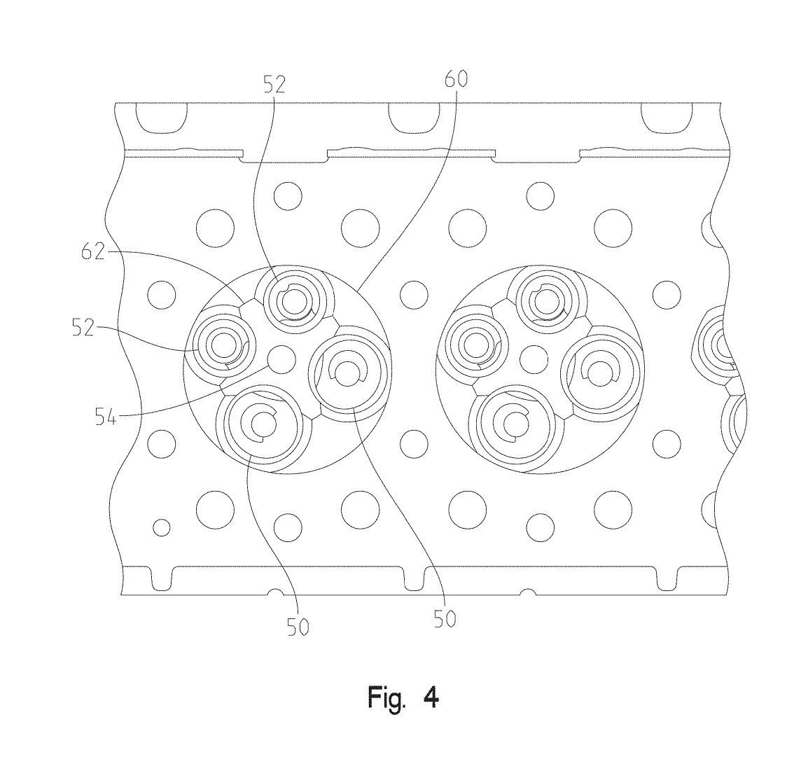

In the present embodiment, the fuel supplied to the cylinder is a spark ignited fuel. In the present example, the fuel is a gaseous spark ignited fuel, such as natural gas. However, it should be appreciated that the disclosure herein finds utility for multiple fuels, including those fuels that are mixed with charge prior to timed ignition. Accordingly, the igniter (bore 54) is supplied to provide a spark and ignite the fuel. The igniter (bore 54) is exposed to cylinder 60 via cylinder head combustion face 62. The igniter bore 54 is not disposed in the center of cylinder head combustion face 62 but rather is offset from the center. This is shown most clearly in FIG. 2 and in FIG. 4. In the present embodiment, igniter bore 54 is offset in the direction of exhaust valve bores 52. Embodiments are envisioned where igniter bore 54 is offset between 2% and 8% of the overall cylinder diameter. Moving igniter bore 54 from the central position allows the needed wall thickness between valve ports/bores 50, 52 and the igniter port/bore 54 such that impingements into valve ports 50, 52 are not needed, or reduced, to facilitate the placement of igniter (bore 54). This placement of igniter bore 54 allows increased charge flow thereby increasing volumetric efficiency.

It should be appreciated that intake air passing over/around/near the intake valves (via bores 50) has a cooling effect thereon. Similarly, the heated exhaust passing over/around/near the exhaust valves (via bores 52) has a heating effect thereon. Accordingly, exhaust valves are often warmer than intake valves. As a piece having increased temperature, exhaust valves present a piece with increased potential to be a secondary source of fuel ignition within the cylinder 60. Such a secondary ignition source is a potential source of knock within the engine 12. The “offset” of igniter bore 54 towards the exhaust valve bores 52 also serves to reduce the distance between the ignition source (bore 54) and the heated exhaust valves (bores 52). Accordingly, in the event of a secondary ignition via the exhaust valves (bores 52), the primary (igniter, bore 54) and secondary (exhaust valves, bores 52) ignition sources are closer together which thereby lessens the potential for secondary, uncontrolled ignition and knock, and lessens any effect (such as knock production) that such uncontrolled ignitions have.

The above detailed description and the examples described therein have been presented for the purposes of illustration and description only and not for limitation. For example, the operations described may be done in any suitable manner. The method steps may be done in any suitable order still providing the described operation and results. It is therefore contemplated that the present embodiments cover any and all modifications, variations or equivalents that fall within the spirit and scope of the basic underlying principles disclosed above and claimed herein.

What is claimed is:

1. An engine including:
a gaseous fuel system;
a cylinder including a flat combustion face, the flat combustion face including four valves, each valve positioned in a port, the four valves including two intake valves positioned to selectively meter intake of charge into the cylinder via respective ports and including two exhaust valves positioned to selectively meter output of exhaust from the cylinder via respective ports;
each of the ports for the four valves defining a port diameter; the port diameter for the intake valves being greater than the port diameter for the exhaust valves.

2. The engine of claim 1, wherein each of the four valves travels along a respective longitudinal axis, the respective longitudinal axes for the four valves being parallel.

3. The engine of claim 1, wherein there are exactly two exhaust valves.

4. The engine of claim 1, wherein there are exactly two intake valves.

5. The engine of claim 1, wherein the port diameter for the intake valves and the port diameter for the exhaust valves define a ratio in the range of 1.4:1 to 1.1:1.

6. The engine of claim 1, wherein the number of intake valves for the cylinder is equal to the number of exhaust valves for the cylinder.

7. An engine including:
a gaseous fuel system;
a cylinder including four valves defined in a circular combustion face of the cylinder, the four valves each including a valve head, the valve heads presenting co-planar combustion surfaces;
an ignition source disposed in the combustion face, the ignition source being offset from a center of the combustion face in a direction towards the exhaust valves.

8. The engine of claim 7, wherein the ignition source is a spark plug.

9. The engine of claim 7, wherein each of the four valves travels along a respective longitudinal axis, the respective longitudinal axes for the four valves being parallel.

10. The engine of claim 7, wherein the number of intake valves for the cylinder is equal to the number of exhaust valves for the cylinder.

11. The engine of claim 7, wherein the valves have a collective mass and the center of mass of the valves is offset from the center of the combustion face.

12. The engine of claim 7, further including a controller operable to control operation of the valves and ignition source.

13. The engine of claim 7, wherein each valve includes a valve port each of the ports for the four valves defining a port diameter; the port diameter for the intake valves being greater than the port diameter for the exhaust valves.

14. The engine of claim 7, wherein the ignition source is disposed in an igniter bore that is offset from the center combustion face between 2% and 8% of the combustion face diameter.

15. The engine of claim 7, wherein ignition source is closer to a center of each of the exhaust valves than to a center of each of the intake valves.

16. The engine of claim 7, wherein each valve includes a port having a diameter, the port diameter for the intake valves is larger than the port diameter for the exhaust valves.

17. The engine of claim 16, wherein each valve includes a port having a diameter, the port diameter for the intake valves and the port diameter for the exhaust valves define a ratio in the range of 1.4:1 to 1.1:1.

18. A method of producing a cylinder combustion face for a gaseous fuel system including:
forming intake ports having a first diameter in a circular combustion face;
forming exhaust ports having a second diameter in the circular combustion face; and
forming an ignition bore in the circular combustion face, the first diameter being larger than the second diameter, the intake and exhaust ports being oriented such that valve heads received therein present co-planar combustion surfaces.

19. The method of claim 18, wherein forming the ignition bore includes forming the ignition bore at a location offset from a center of the circular combustion face.

20. The method of claim 19, wherein the ignition bore is offset from the center of the circular combustion face in a direction towards the exhaust ports.
